(19) United States
(12) Patent Application Publication
(10) Pub. No.: US 2009/0053608 A1
(43) Pub. Date: Feb. 26, 2009

(54) Anode active material hybridizing carbon nanofiber for lithium secondary battery

(76) Inventors: Im Goo Choi, Yuseong-gu (KR); Seung Yeon Jang, Yuseong-gu (KR); Namsun Choi, Yuseong-gu (KR); Hyun-Kyung Sung, Yuseong-gu (KR); Dong Hwan Kim, Yuseong-gu (KR); Youngchan Jang, Yuseong-gu (KR); Hangi Jung, Buk-gu (KR)

Correspondence Address: KENYON & KENYON LLP, 1500 K STREET N.W., SUITE 700, WASHINGTON, DC, 20005, US

(21) Appl. No.: 12/213,830

(22) Filed: Jun. 25, 2008

(30) Foreign Application Priority Data
Jun. 29, 2007 (KR) 10-2007-65592

(51) Int. Cl. H01M 4/40

(52) U.S. Cl. 429/231.95

(57) ABSTRACT

The present invention provides a composite silicon anode material hybridizing carbon nanofiber for lithium secondary battery prepared by the steps comprising: i) preparing a support made by amorphous silicon alloy after processing amorphous silicon and metal; ii) dispersing the catalyst selected from Fe, Co, Ni, Cu, Mg, Mn, Ti, Sn, Si, Zr, Zn, Ge, Pb or In on the surface of said support made by amorphous silicon alloy; and iii) growing the carbon nanofiber using a carbon source selected from carbon monoxide, methane, acetylene or ethylene on said support by a chemical vapor deposition method, wherein the amount of grown carbon nanofiber is 1˜110 wt % of the amount of said support.

### BACKGROUND OF THE INVENTION

1. Field of the Invention

The present invention relates to a composite silicon anode active material hybridizing carbon nanofiber having high capacity and high safety for lithium secondary battery. More specifically, this invention relates to a composite silicon anode active material for lithium secondary battery prepared by the steps comprising: i) preparing a support made by amorphous silicon alloy after processing amorphous silicon and metal; ii) dispersing the catalyst to the surface of said support made by amorphous silicon alloy; and iii) growing the carbon nanofiber on said support.

2. Description of Prior Art

In 21st century, the new paradigm of information technology capable of multi-media interactive communication has been introduced, according to the development of semiconductor which affords the small size of portable telecommunication devices, such as notebook computer, mobile and DMB phone. In accordance with the needs of multi-functional electronic devices, high capacity and high voltage secondary battery has been studied and developed with respect to electrode material. Energy density and capacity of secondary battery have been rapidly increased, since SONY developed and marketed its first graphite based lithium ion secondary battery in early 90's. However, the development of secondary battery, which contains higher capacity, higher charge/discharge capacity and higher cyclic stability than what it does, has been still required. Because the capacity of battery depends on the charge/discharge properties of anode material, the improvement of anode active material has been a main issue in the development of secondary battery.

The various kinds of surface reforming researches of anode active material, such as inorganic coating, crystalline carbon coating, pyro-carbon coating, carbon nanofiber dispersion or carbon nano tube dispersion, have been carried out in order to improve the electrochemical properties of carbon graphite anode material in secondary battery. Such methods prevent the destruction of crystalline structure in anode material in the course of intercalating/de-intercalating the lithium ions in lithium secondary battery. On the other hand, natural graphite anode material coated with crystalline carbon has been developed in order to improve the charge and discharge properties of lithium secondary battery.

Many technologies have been disclosed to improve charging/discharging capacities of anode material using graphite in lithium secondary battery.

Korean Patent No. 529,069 ‘Anode active material for lithium secondary battery and its preparation method’ disclosed crystalline anode active material coated with an amorphous carbon layer. Further, U.S. Pat. Appl. Pub. No. 2004/0137328 A1 ‘Negative active material for rechargeable lithium battery and method of preparing same’ disclosed a negative active material of a rechargeable lithium battery comprising: a crystalline carbon core having an intensity ratio Ra I(1360)/I(1580) of a Raman Spectroscopy peak intensity I(1360) at 1360 cm⁻¹ to a Raman Spectroscopy peak intensity I(1580) at 1580 cm⁻¹ is 0.01 to 0.45; and a shell with a turbostratic or half-onion ring structure coated on the core.

On the other hand, in Korean Patent Early publication No. 2005-99697, ‘Anode active material for lithium secondary battery and lithium secondary battery containing said anode’ and Korean Patent Early publication No. 2005-100505, ‘Anode active material for lithium secondary battery and lithium secondary battery’, it has been disclosed, respectively, that grinded plate graphite powder and amorphous carbon particles are subsequently assembled to prepare the anode active material. However, the anode active material prepared by amorphous carbon coating to plate type or fiber type of active material cannot be commercially applied, because non-reversible capacity of battery increases accordingly with the increase of reversible capacity and surface area.

On the other hand, metals have been used as material for reforming the carbon anode material. Tasutomu Takamura et al disclosed that charging/discharging properties have been enhanced by metal lamination coating to the graphite anode material surface using Ag, Au, Bi, I or Zn according to the metal heating deposition method (Journal of Power Source 81-82 pp 368-372 (1999)). U.S. Pat. No. 6,797,434 disclosed that anode active material includes a mixture of carbonaceous material and an amorphous metal compound, such as tin oxide. Further, in Korean Patent Early publication No. 2004-100058, ‘Anode active material for lithium secondary battery and its preparation method’, it has been disclosed that anode active material is prepared by a carbon/metal complex using carbon material and a metal precursor.

Further, Korean Patent No. 536,247 ‘Anode active material for lithium secondary battery and lithium secondary battery containing said anode’ disclosed that anode active material is prepared by forming the inorganic oxide or hydroxide layer, such as Al, Ag, B, Zn, or Zr to the surface of graphite carbon material according to the heat treatment process. However, in order to reform the carbon anode surface using metals according to the above mentioned methods, the surface coating material shall be uniformly dispersed before coating. Further, to obtain a uniformed metal oxide layer, a large amount of metal precursors shall be required. On the other hand, a plate type of graphite is hard to be uniformly dispersed, which requires additional heat treatment to prepare the layer having uniformed thickness.

Carbon nano material, such as vapor-grown carbon fibers (VGCF), carbon nano tubes, carbon nanofibers or fullerene has been developed as carbon electrode material. Further, PCT Patent pamphlet WO 03/67699 A2 disclosed that anode active material for lithium battery is prepared by mixed materials of spherical graphite of meso-phase carbon micro-balls; carbon nano-fibers (VGCF) of 200 nm diameter and 65˜70 nm inner core diameter; and an ion conducting polymeric binder. Further, Japanese Patent Early publication No. 2004-227988 disclosed that graphite carbon nanofibers are added to graphite anode active material as a conductive agent, which shows excellent charging/discharging capacity compared to that of a conventional conductive agent.

Since carbon nano material, such as the carbon nanotube or the carbon nanofiber has large surface area, such material has a handicap due to the high ratio of volume to weight in the electrode. Therefore, according to the increase of amount of carbon nano material, the processibility of electrode has to be declined due to the difficulty of binding the nano material with current collector in the electrode. Further, the high cost of carbon nano material compared to graphite is another handicap for commercializing.

To overcome the problems for using the carbon nanotube or the carbon nanofiber as anode active material, Korean Patent No. 566,028 ‘Carbon nano material for anode active material of lithium secondary battery and its preparation method’ disclosed the carbon nanofiber complex with metal particles, such as Ag, Sn, Mg, Pd, or Zn as anode active material. However, the simple complex of carbon nano material with anode material causes another handicap, because the growth of carbon nanofibers is made in an irregular direction and carbon nanofibers have a large volume density in the electrode. In this case, carbon nanofibers have a main role of anode active material, which results in low cyclic property of the carbon nanofiber itself. To overcome low cyclic property of carbon nanofibers, anode active material shall be prepared by introducing heat treatment process at more than 2000° C. Even though the electro-conductivity between anode active materials can be enhanced by adding a conductive agent, the decomposition of structure caused by fundamental volume expansion cannot be avoided in the course of charging and discharging cycles.

U.S. Pat. No. 6,808,846 B2 ‘Negative electrode for lithium secondary battery and manufacturing method thereof’ disclosed an electrode obtained by sintering a mixture of an active material alloy and a binder arranged on a current collector made of metallic foil, or sintering a mixture of the active material alloy, conductive metal powder and a binder arranged on a current collector made of metallic foil. Further, it has been disclosed that the active material alloy after sintering is substantially amorphous and contains silicon. However, only silicon alloy has been disclosed as a negative electrode active material in this disclosure. There has been no description about carbon nanofiber grown on negative electrode active material. Further, in case that amorphous silicon has been used as negative electrode active material, it has been still a problem of both controlling the size of particles and suppressing the volume expansion of silicon.

Japanese Patent Early Publication No. 2006-244984 ‘Composite particle for electrode, its manufacturing method and nonaqueous electrolyte secondary battery’ disclosed the composite particle for the electrode containing active material particles, carbon nano-fibers bonded on the surface of the active material particle and catalyst elements for enhancing the growth of carbon nano-fiber. Further, it has been disclosed that catalyst elements include at least one selected from Au, Ag, Pt, Ru, Ir, Cu, Fe, Co, Ni, Mo and Mn. Therefore, an anode active material made by transition metal particles on which carbon nanofibers are bonded has been disclosed. However, there has been no disclosure about an anode active material using silicon as main material on which carbon nanofibers are grown.

The inventors of present application have already disclosed U.S. Appl. Pub. No. 2008/0020282 ‘Anode active material hybridizing carbon nanofibers for lithium secondary battery’. In this publication, an anode active material hybridized with carbon nanofibers for lithium secondary battery prepared by following steps comprising, i) dispersing the nano size metal catalyst to the surface of anode material selected from graphite, amorphous silicon or the complex of graphite and amorphous silicon; and ii) growing the carbon nanofiber by chemical vapor deposition method, wherein carbon nanofibers are grown in a vine form and surround the surface of anode active material.

In U.S. Appl. Pub. No. 2008/0020282, the inventors of present application suggested the solution of following problems occurred in U.S. Pat. No. 6,440,610 B1 ‘Negative active material for lithium secondary battery and manufacturing method of same’, such as, the decline of active anode material density which results from increase of volume density because carbon nano material is grown in a vertical direction or a slope direction from the surface of anode active material. Therefore, according to the anode active material disclosed in this patent publication, we have accomplished the optimal control of particle dispersion and suppression of volume expansion as to anode active material in lithium secondary battery. However, this patent publication discloses only an anode active material made by natural graphite, amorphous silicon and/or the complex of graphite and amorphous silicon as main support, but not an anode material made by silicon or silicon alloy as main support.

Since silicon has handicaps of volume expansion during the charging/discharging cycles when used as anode active material, silicon or silicon alloy cannot be used as main support of anode active material for growing carbon nanofiber even though silicon has an excellent electrochemical capacity compared to natural graphite. Therefore, a silicon anode active material hybridizing carbon nanofiber cannot be developed for commercial uses.

To solve problems stated above, the inventors of present application developed a composite silicon anode material for lithium secondary battery prepared by the steps comprising: i) preparing a support made by amorphous silicon alloy after processing amorphous silicon and metal; ii) dispersing the catalyst to the surface of said support made by amorphous silicon alloy; and iii) growing the carbon nanofiber on said support. Therefore, a composite silicon anode material hybridizing carbon nanofiber in present application affords not only high capacity and high safety, but also suppression of volume expansion of silicon material during the charging/discharging cycles.

### SUMMARY OF THE INVENTION

The object of the present invention is to provide a composite silicon anode material hybridizing carbon nanofiber for lithium secondary battery prepared by the steps comprising: i) preparing a support made by amorphous silicon alloy after processing amorphous silicon and metal; ii) dispersing the catalyst selected from Fe, Co, Ni, Cu, Mg, Mn, Ti, Sn, Si, Zr, Zn, Ge, Pb or In on the surface of said support made by amorphous silicon alloy; and iii) growing the carbon nanofiber using a carbon source selected from carbon monoxide, methane, acetylene or ethylene on said support by a chemical vapor deposition method, wherein the amount of grown carbon nanofiber is 1˜110 wt % of the amount of said support.

Further, said amount of grown carbon nanofiber is preferably 4˜100 wt % of the amount of said support.

Further, said metal is at least one selected from the group consisting of Mg, Ca, Sr, Ba, Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Hg, Al, Sn, and Sb.

Further, the ratio (I_{alloy}/Iₛᵢ) of peak intensity of silicon alloy (I_{alloy}) as to peak intensity of silicon (Iₛᵢ) measured by X-ray Diffractometer is in the range of 0.2˜5 in order to define the silicon amount in the silicon alloy.

Further, the ratio (I_{alloy}/Iₛᵢ) of peak intensity of silicon alloy (I_{alloy}) as to peak intensity of silicon (Iₛᵢ) measured by X-ray Diffractometer is preferably in the range of 0.4˜2.0 in order to define the silicon amount in the silicon alloy.

On the other hand, said preparation steps further comprise a reforming step from silicon alloy powder into amorphous silicon alloy powder before preparing a support.

Further, the ratio (W_{after}/W_{before}) of full width at half maximum of silicon alloy powder after reforming the silicon alloy powder as to that of before reforming the silicon alloy powder measured by X-ray Diffractometer is in the range of 1.05˜30 in order to define the amorphous degree of reformed silicon alloy.

Further, the ratio (W_{after}/W_{before}) of full width at half maximum of silicon alloy powder after reforming the silicon alloy powder as to that of before reforming the silicon alloy measured by X-ray Diffractometer is preferably in the range of 1.1˜10 in order to define the amorphous degree of reformed silicon alloy.

Further, the roundness of amorphous silicon alloy powder is in the range of 40˜100% in order to define the shape of amorphous silicon alloy powder.

### BRIEF DESCRIPTION OF THE DRAWINGS

FIG. 1 is a XRD peak intensity data. Regarding anode active material prepared in Preparation Example 1, peak intensity of CU₃Si is strong whereas Si peak intensity and Cu peak intensity are weak. Regarding anode active material prepared in Comparative Preparation Example 1, peak intensity of CU₃Si is weak whereas Si peak intensity and Cu peak intensity are strong. This means that the produced amount of CU₃Si alloy in Preparation Example 1 is higher than that of Comparative Preparation Example 1.

FIG. 2 is a XRD data which indicates that full width at half maximum of sufficiently reformed the silicon alloy powder (Preparation Example 2) is larger than that of insufficiently reformed the silicon alloy powder (Comparative Preparation Example 2).

FIG. 3A is a BSE mode photograph of Field Emission Scanning Electron Microscope (FE-SEM), where the growth of carbon nanofiber is enhanced when the silicon support powder has excellent roundness. FIG. 3B is a BSE mode photograph of Field Emission Scanning Electron Microscope (FE-SEM), where the growth of carbon nanofiber is weakened when the silicon support powder has poor roundness.

FIG. 4A is a Field Emission Scanning Electron Microscope (FE-SEM) photograph, where the growth of carbon nanofiber is uniform when the silicon support powder has excellent roundness. FIG. 4B is an enlarged FE-SEM photograph of a part of FIG. 4A.

FIG. 5A is a Field Emission Scanning Electron Microscope (FE-SEM) photograph, where the growth of carbon nanofiber is not uniform when the silicon support powder has poor roundness. FIG. 5B is an enlarged FE-SEM photograph of a part of FIG. 5A.

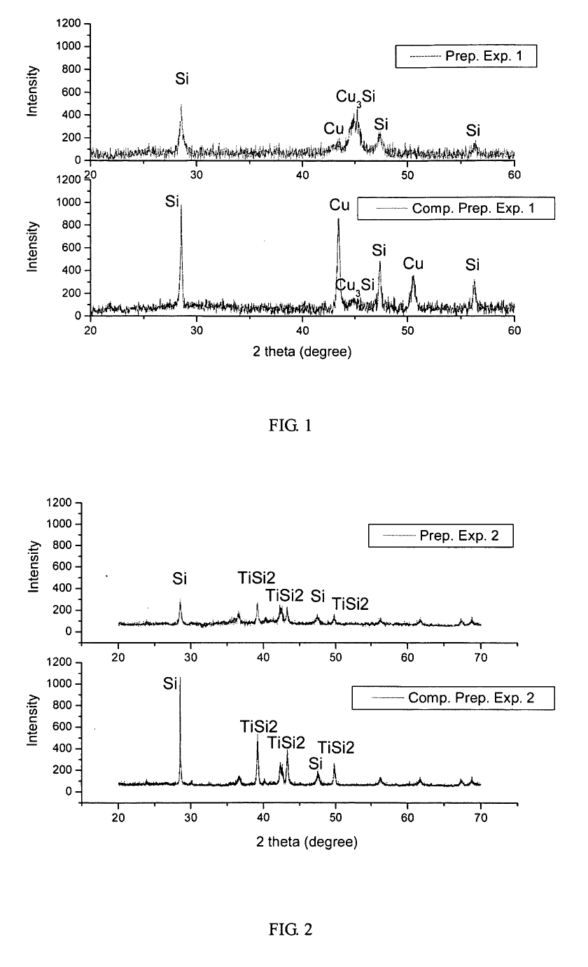

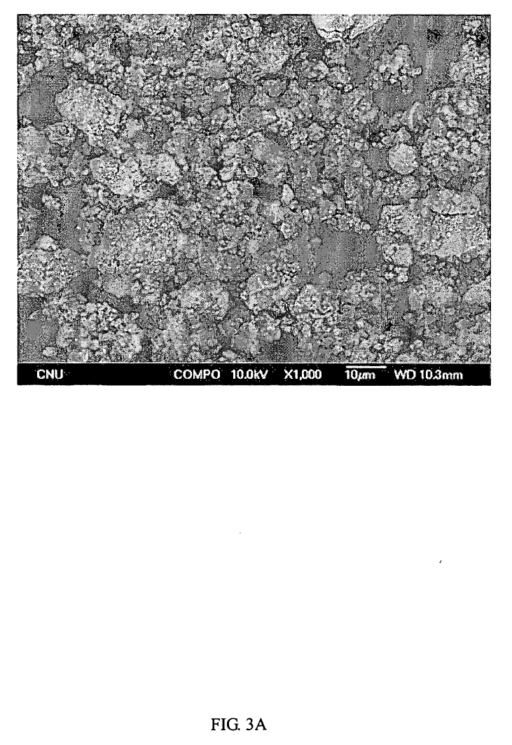

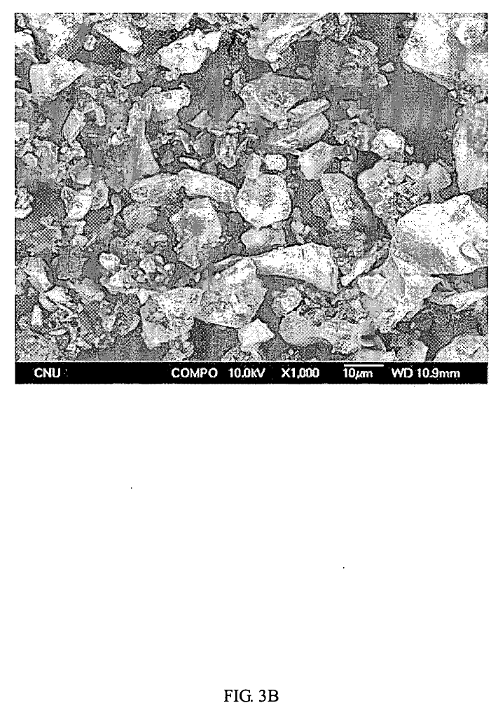

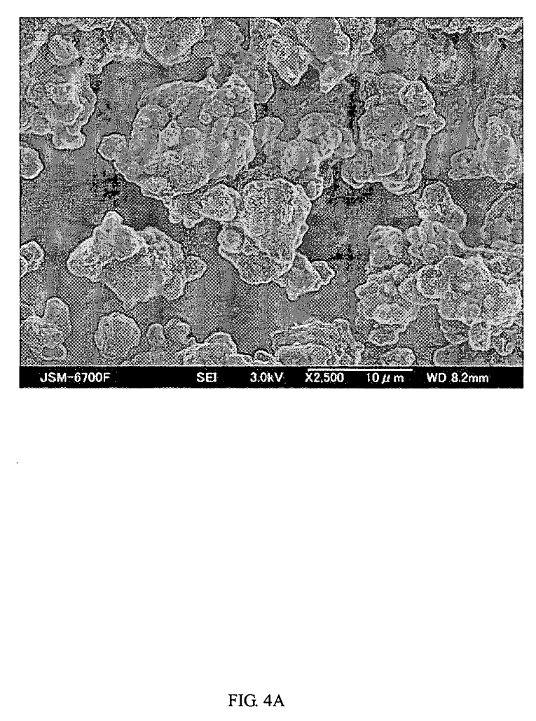

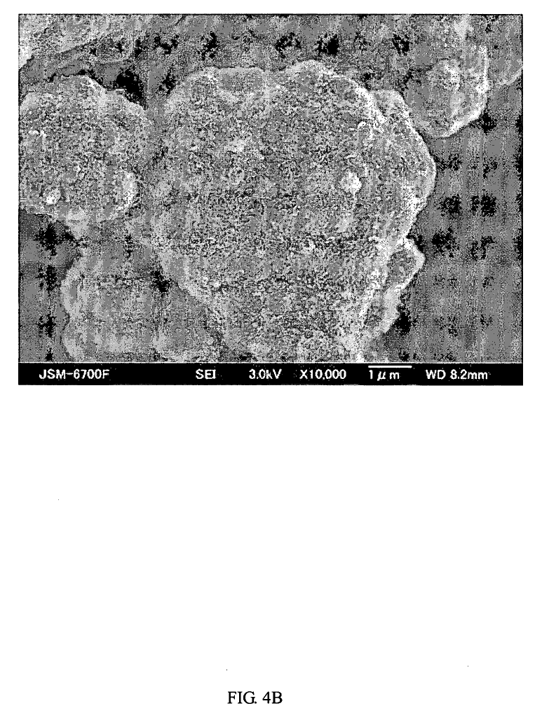

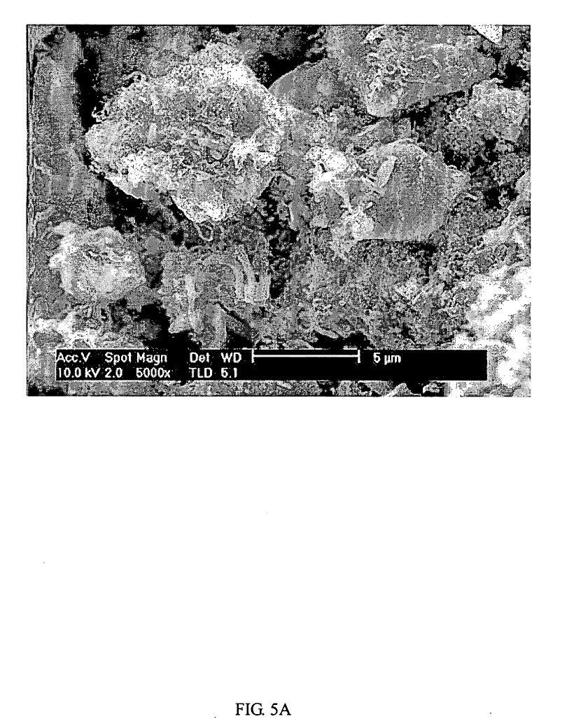

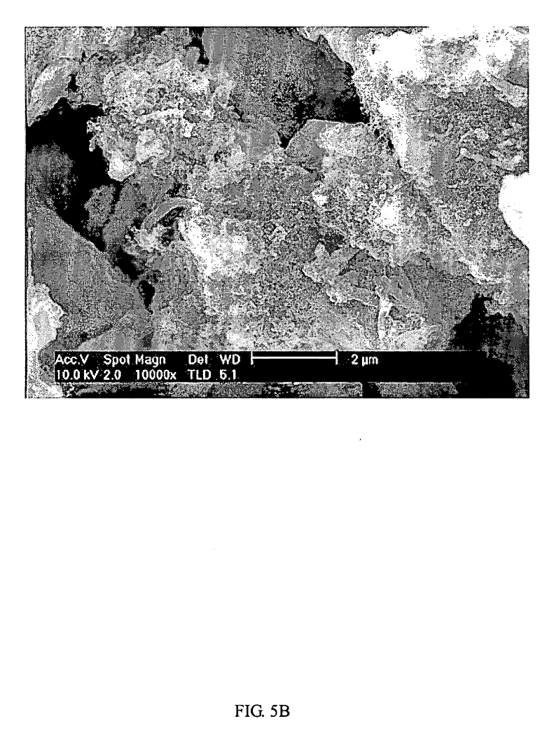

### DETAILED DESCRIPTION OF THE INVENTION

The present invention affords a composite silicon anode material hybridizing carbon nanofiber for lithium secondary battery prepared by the steps comprising: i) preparing a support made by amorphous silicon alloy after processing amorphous silicon and metal; ii) dispersing the catalyst selected from Fe, Co, Ni, Cu, Mg, Mn, Ti, Sn, Si, Zr, Zn, Ge, Pb or In on the surface of said support made by amorphous silicon alloy; and iii) growing the carbon nanofiber using a carbon source selected from carbon monoxide, methane, acetylene or ethylene on said support by a chemical vapor deposition method.

Further, the ratio (I_{alloy}/Iₛᵢ) of peak intensity of silicon alloy (I_{alloy}) which has at least one metal selected from the group consisting of Mg, Ca, Sr, Ba, Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Hg, Al, Sn, and Sb as to peak intensity of silicon (Iₛᵢ) measured by X-ray Diffractometer is in the range of 0.2˜5 (0.2<I_{alloy}/Iₛᵢ<5) in order to define the silicon amount in the silicon alloy. The ratio (I_{alloy}/Iₛᵢ) of peak intensity of silicon alloy (I_{alloy}) as to peak intensity of silicon (Iₛᵢ) measured by X-ray Diffractometer is preferably in the range of 0.4˜2.0 (0.4<I_{alloy}/Iₛᵢ<2.0).

Further, the ratio (W_{after}/W_{before}) of full width at half maximum of silicon alloy powder after reforming the silicon alloy powder as to that of before reforming the silicon alloy powder measured by X-ray Diffractometer is in the range of 1.05˜30 (1.05<W_{after}/W_{before}<30) in order to define the amorphous degree of reformed silicon. The ratio (W_{after}/W_{before}) of full width at half maximum of silicon powder after reforming the silicon alloy powder as to that of before reforming the silicon alloy powder measured by X-ray Diffractometer is preferably in the range of 1.110 (1.1<W_{after}/W_{before}<10).

Further, the roundness of amorphous silicon alloy powder is in the range of 40˜100% in order to define the shape of amorphous silicon powder or silicon alloy powder.

Further, the amount of grown carbon nanofiber is 1˜110 wt % of the amount of said support. The amount of grown carbon nanofiber is preferably 2˜100 wt % of the amount of said support.

The present application has developed a composite silicon anode material for lithium secondary battery, wherein said composite silicon anode material suppresses the expansion of silicon as well as enhances the uniform growth and the high adhesiveness of carbon nanofiber. Further, said composite silicon anode material also affords proper electrode packing density and high electro-conductivity as anode active material. Of course, the lithium secondary battery prepared by said composite silicon anode material can afford excellent electro-capacity, consistency and safety.

Further, by developing a composite silicon anode material of present application, silicon material which has handicaps as anode active material due to the volume expansion of silicon during the cycling of charging/discharging can be used as main support of anode material. Of course, a composite silicon anode material hybridizing carbon nanofiber can be used as a more excellent anode active material which shows excellent electrochemical capacity, consistency and safety according to the charging/discharging cycles.

The silicon alloy which comprises silicon and metal affords the suppression of volume expansion of silicon, because metal has a complementary role for expansion of silicon. Further, if metal is a semi-metal element, the electro-conductivity of silicon alloy can be enhanced. Therefore, silicon alloy composed of silicon and semi-metal is preferred. The metal element can be at least one selected from the group consisting Mg, Ca, Sr, Ba, Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Hg, Al, Sn, and Sb.

Further, the ratio (I_{alloy}/Iₛᵢ) of peak intensity of silicon alloy (I_{alloy}) as to peak intensity of silicon (Iₛᵢ) measured by X-ray Diffractometer is in the range of 0.2˜5 (0.2<I_{alloy}/Iₛᵢ<5), preferably in the range of 0.4˜2.0 (0.4<I_{alloy}/Iₛᵢ<2.0). If the ratio (I_{alloy}/Iₛᵢ) of peak intensity of silicon alloy (I_{alloy}) as to peak intensity of silicon (Iₛᵢ) is more than 5, the amount of silicon that receives lithium ion becomes so little that charging/discharging capacity of anode is declined since most of silicon is present in the form of alloy. On the other hand, if the ratio (I_{alloy}/Iₛᵢ) of peak intensity of silicon alloy (I_{alloy}) as to peak intensity of silicon (Iₛᵢ) is less than 0.2, the amount of silicon that receives lithium ion becomes so much that the expansion of silicon cannot be suppressed since most of silicon is present in the form of silicon rather than alloy.

When silicon is amorphous, the volume expansion of silicon when receiving lithium ion is nominal compared to that of crystalline silicon. Therefore, it is important that silicon shall be prepared in an amorphous form. To measure the amorphous degree of silicon, full width at half maximum measured by X-ray Diffractometer has been used. If the amorphous property of silicon increases, the full width at half maximum becomes large. Therefore, the amorphous degree of silicon before reforming and after reforming can be defined by measuring full width at half maximum measured by X-ray Diffractometer.

Further, the ratio (W_{after}/W_{before}) of full width at half maximum of silicon alloy powder after reforming the silicon alloy powder as to that of before reforming the silicon alloy powder measured by X-ray Diffractometer is in the range of 1.05˜30, preferably in the range of 1.1˜10. If the ratio (W_{after}/W_{before}) is more than 30, excessive amorphous degree of silicon after reforming causes the irreversible reaction on the surface of silicon powder. On the other hand, if the ratio (W_{after}/W_{before}) is less than 1.05, insufficient amorphous degree of silicon after reforming cannot suppress the volume expansion of silicon when lithium ion is intercalated.

If the shape of silicon support has large number of edges or planes, the growth of carbon nanofiber on silicon alloy support has some difficulties. Therefore, roundness of silicon support powder is helpful for growing the carbon nanofiber on silicon alloy support. It is preferred that the roundness of silicon alloy powder is in the range of 40˜100%. If the roundness of silicon alloy is less than 40%, the growth of carbon nanofiber on silicon alloy support cannot be uniform with declining adhesiveness of carbon nanofiber on the surface of silicon alloy support.

Further, said amount of grown carbon nanofiber on silicon alloy support is 1˜110 wt %, preferably 4˜100 wt % of the amount of said support. If the amount of grown carbon nanofiber is more than 110 wt % of the amount of silicon alloy support, the electrode packing density of anode becomes low, which causes the decline of electro-capacity per volume of anode. On the other hand, if the amount of grown nanofiber is less than 1 wt %, the effect of carbon nanofiber cannot be accomplished.

The present application can be explained more concretely by following Preparation Examples, Comparative Preparation Examples, Examples and Comparative Examples. However, the scope of the present application shall not be limited by following Examples.

### EXAMPLES

### Preparation Example 1

### Preparation of Anode Active Material Hybridizing Carbon Nanofiber

20 g of Si powder (made in China, more than 99.9% purity, #270 sieve treatment) and 20 g of Cu powder (Aldrich, more than 99% purity) are milled by Agitation Mill (ITOH, made in Japan) at argon atmosphere for 48 hours. In the presence of said powder as a support, carbon nanofiber has been grown by chemical vapor deposition method using ethylene gas and 5 wt % of Ni catalyst.

### Preparation Example 2

### Preparation of Anode Active Material Hybridizing Carbon Nanofiber

20 g of Si agglomerate (made in China, more than 99.9% purity) and 4 g of Ti rod (Aldrich, more than 99.7% purity) are melted at 1,500° C. using a melt spinning method. Then, melted product is rapidly cooled at a rate of 10⁷ K/sec. The obtained powder is milled by SPEX Mill (Fritzch, Germany) at argon atmosphere for 4 hours. In the presence of said powder as a support, carbon nanofiber has been grown by chemical vapor deposition method using ethylene gas and 5 wt % Ni catalyst.

### Preparation Example 3

### Preparation of Anode Active Material Hybridizing Carbon Nanofiber

20 g of Si powder and 20 g of Mg powder (Aldrich, more than 99% purity) are milled by SPEX Mill (Fritzch, Germany) at argon atmosphere for 10 hours. Then, 20 wt % of petrochemical pitch (made in China, 200° C. softening point) is added and mixed. After said powder is further milled by the same manner by SPEX Mill (Fritzch, Germany) at argon atmosphere for 2 hours, the obtained powder is carbonized at 650° C. for 2 hours. In the presence of said powder as support, carbon nanofiber has been grown by chemical vapor deposition method using ethylene gas and 5 wt % Co catalyst.

### Preparation Example 4

### Preparation of Anode Active Material Hybridizing Carbon Nanofiber

20 g of Si powder, 10 g of Fe powder and 20 g of Mg powder are milled by SPEX Mill (Fritzch, Germany) at argon atmosphere for 8 hours. Then, the obtained powder is heat-treated at 800° C. for 2 hours. In the presence of said powder as support, carbon nanofiber has been grown by chemical vapor deposition method using ethylene gas and 5 wt % Ni catalyst.

### Preparation Example 5

### Preparation of Anode Active Material Hybridizing Carbon Nanofiber

20 g of Si powder, 20 g of Fe powder (made in China, more than 99.9% purity, #270 sieve treatment) and 5 g of graphite powder (made in China, more than 99.5% purity) are added and mixed. Then, the obtained powder is milled by SPEX Mill (Fritzch, Germany) at argon atmosphere for 4 hours and is reduced at 600° C. for 3 hours with H₂ at a rate of 500 ml/min. In the presence of said powder as support, carbon nanofiber has been grown by chemical vapor deposition method using ethylene gas and 5 wt % Ni catalyst.

### Preparation Example 6

### Preparation of Anode Active Material Hybridizing Carbon Nanofiber

5 g of Ni powder (Aldrich, more than 99% purity) is added to the anode active material obtained in Preparation Example 1. The carbon nanofiber has been grown as the same manner in Preparation Example 1. Further, 20 wt % of phenol resin is added and mixed to the obtained anode active material. Then, heat-treatment at 200° C. for 2 hours and further heat-treatment at 900° C. for 2 hours have been consecutively made. The anode active material in the form of carbon coated powder is finally obtained.

### Comparative Preparation Example 1

### Preparation of Anode Active Material Hybridizing Carbon Nanofiber (Insufficiency of Produced Silicon Alloy)

A negative electrode material is prepared as the same manner of Preparation Example 1 except being milled for 10 hours instead of 48 hours. Therefore, only small amount of silicon alloy (Cu₃Si) has been prepared compared to that of Preparation Example 1. Further, carbon nanofiber has been grown as the same manner of Preparation Example 1.

### Comparative Preparation Example 2

### Preparation of Anode Active Material Hybridizing Carbon Nanofiber (Insufficiency of Amorphous Degree of Alloy Measured by Full Width at Half Maximum by XRD)

A negative electrode material is prepared as the same manner of Preparation Example 2 except that the obtained powder using melt-spinning and rapid cooling method as the same manner of Preparation Example 2 is milled by SPEX Mill (Fritzch, Germany) at argon atmosphere for 1 hour. Further, carbon nanofiber has been grown as the same manner of Preparation Example 2.

### Comparative Preparation Example 3

### Preparation of Anode Active Material Hybridizing Carbon Nanofiber (the Excessive Amount of Grown Carbon Nanofiber)

A negative electrode material is prepared as the same manner of Preparation Example 3 except that carbon nanofiber has been excessively grown under the same condition of Preparation Example 3.

### Comparative Preparation Example 4

### Preparation of Anode Active Material Hybridizing Carbon Nanofiber (Non-Growth of Carbon Nanofiber)

A negative electrode material is prepared as the same manner of Preparation Example 4 except that carbon nanofiber has not been grown on the support.

### Measurement of Properties of Anode Active Materials Prepared in Preparation Examples 1˜6 and Comparative Preparation Examples 1˜4

Regarding anode active materials prepared in Preparation Examples 1˜6 and Comparative Preparation Examples 1˜4, we have measured following properties.

X-ray Diffractometer used in these Examples is made by MAC Co. (Japan). Further, Cu Kα-ray is used at 40 kV of voltage and 30 mA of current. The rate of X-ray illumination is 0.01°/sec. From the pattern of X-ray diffraction, the peak intensity and the full width at half maximum of silicon alloy are measured through Si (111) plate.

The roundness of silicon alloy powder is measured by Particle Count Analyser made in Miraero Systems Co. (Korea). Further, resolution images are analyzed at 3.5 nm of resolution rate and 4 frame/min of rate.

The amount of grown carbon nanofiber is calculated by measuring the difference between the weight of silicon alloy support before growing carbon nanofiber and the weight of silicon alloy support before after growing carbon nanofiber.

The measured items of anode active material made by silicon alloy are as follows.

i) The ratio (I_{alloy}/Iₛᵢ) of peak intensity of silicon alloy (I_{alloy}) as to peak intensity of silicon (Iₛᵢ) measured by X-ray Diffractometer

ii) The ratio (W_{after}/W_{before}) of full width at half maximum of silicon alloy powder after reforming the silicon alloy powder as to that of before reforming the silicon alloy powder measured by X-ray Diffractometer

iii) The roundness of silicon alloy powder

iv) The amount of grown carbon nanofiber

Table 1 shows the results of above measured properties of anode active material prepared in Preparation Examples 1˜6 and Comparative Preparation Examples 1˜4.

TABLE 1

| | | Full width | Round- | |
|---|---|---|---|---|
| | Peak | at half | ness of | |
| | Intensity | maximum | silicon | Amount of |
| | (I_{alloy}/ | (W_{after}/ | alloy | grown carbon |
| | Iₛᵢ) | W_{before}) | powder | nanofiber |
| Prep. Exp. 1 | 0.9 | 2.4 | 62 | 66 |
| Comp. Prep. Exp. 1 | 0.16 | 1.3 | 45 | 32 |
| Prep. Exp. 2 | 0.8 | 1.8 | 57 | 11 |
| Comp. Prep. Exp. 2 | 0.5 | 0.9 | 21 | 3 |
| Prep. Exp. 3 | 1.3 | 2.7 | 75 | 31 |
| Comp. Prep. Exp. 3 | 1.3 | 2.7 | 75 | 120 |
| Prep. Exp. 4 | 1.8 | 2.3 | 67 | 10 |
| Comp. Prep. Exp. 4 | 1.8 | 2.3 | 67 | 0 |
| Prep. Exp. 5 | 0.8 | 1.9 | 60 | 33 |
| Prep. Exp. 6 | 1.2 | 1.9 | 69 | 70 |

### Examples 1˜6

### Charging/Discharging Test of Anode in Secondary Battery

Anode active material slurry has been prepared by mixing 100 wt part of anode active material prepared in each of the Preparation Examples 1˜6, 10 wt part of styrene butadiene rubber as binder and 5 wt part of carboxymethyl cellulose with water. The obtained slurry is coated on the surface of copper current collector using a doctor blade. Then, coated layer is dried with heated air at 120° C. and is pressed with a roll under 30 of pressure. Finally, a negative electrode is obtained after vacuum drying in vacuum oven for 12 hours.

The charging/discharging capacity of the anode prepared in each of the Examples 1˜6 has been measured. Table 2 shows electrode packing density of anode, initial efficiency of discharging capacity, 2C/0.2C maintenance capacity and maintenance capacity after 50 cycles of charging/discharging.

### Comparative Example 1˜4

### Charging/Discharging Test of Anode in Secondary Battery

Anode active material slurry has been prepared by mixing 100 wt part of anode active material prepared in each of the Comparative Preparation Examples 1˜4, 10 wt part of styrene butadiene rubber as binder and 5 wt part of carboxymethyl cellulose with water. The obtained slurry is coated on the surface of copper current collector using doctor blade. Then, the coated layer is dried with heated air at 120° C. and is pressed with a roll under 30 kgf/cm² of pressure. Finally, a negative electrode is obtained after vacuum drying in vacuum oven for 12 hours.

The charging/discharging capacity of the anode prepared in each of the Comparative Examples 1˜4 has been measured. Table 2 shows electrode packing density of anode, initial efficiency of discharging capacity, 2C/0.2C maintenance capacity and maintenance capacity after 50 cycle of charging/discharging.

As shown in Table 2, charging/discharging capacity of the anode prepared in each of the Comparative Examples 1˜4 has been declined. Further, electrode packing density also has been declined.

TABLE 2

| | Electrode | | Initial | 2 C./0.2 C. | Maintenance capacity |
|---|---|---|---|---|---|
| | packing | Charging/discharging | capacity | maintenance | after 50 cycles of |
| | density | capacity | efficiency | capacity | charging/discharging |
| | (g/cc) | (mAh/cc) | (%) | (%) | (%) |
| Exp. 1 | 1.15 | 914 | 81.9 | 79.9 | 83 |
| Comp. | 1.23 | 738 | 51.2 | 10.9 | 11 |
| Exp. 1 | | | | | |
| Exp. 2 | 1.23 | 1,082 | 78.5 | 87.6 | 86 |
| Comp. | 1.02 | 895 | 50.5 | 9.5 | 5 |
| Exp. 2 | | | | | |
| Exp. 3 | 1.35 | 1,180 | 71.5 | 80.5 | 81 |
| Comp. | 0.67 | 626 | 70.2 | 83.2 | 85 |
| Exp. 3 | | | | | |
| Prep. | 1.44 | 713 | 73.2 | 69.9 | 58 |
| Exp. 4 | | | | | |
| Comp. | 1.69 | 544 | 48.5 | 5.3 | 3 |
| Exp. 4 | | | | | |
| Exp. 5 | 1.35 | 1,021 | 80.2 | 82.6 | 78 |
| Exp. 6 | 1.13 | 916 | 75.8 | 81.9 | 83 |

What is claimed is:

1. A composite silicon anode material hybridizing carbon nanofiber for lithium secondary battery prepared by the steps comprising:
i) preparing a support made by amorphous silicon alloy after processing amorphous silicon and metal;
ii) dispersing the catalyst selected from Fe, Co, Ni, Cu, Mg, Mn, Ti, Sn, Si, Zr, Zn, Ge, Pb or In on the surface of said support made by amorphous silicon alloy; and
iii) growing the carbon nanofiber using a carbon source selected from carbon monoxide, methane, acetylene or ethylene on said support by a chemical vapor deposition method, wherein the amount of grown carbon nanofiber is 1˜110 wt % of the amount of said support.

2. The composite silicon anode material according to claim 1, said amount of grown carbon nanofiber is preferably 4˜100 wt % of the amount of said support.

3. The composite silicon anode material according to claim 1, said metal is at least one selected from the group consisting of Mg, Ca, Sr, Ba, Ti, V, Cr, Mn, Fe, Co, Ni, Cu, Zn, Zr, Nb, Mo, Ru, Rh, Pd, Ag, Cd, Hf, Ta, W, Re, Os, Ir, Pt, Au, Hg, Al, Sn, and Sb.

4. The composite silicon anode material according to claim 1, the ratio (I_{alloy}/Iₛᵢ) of peak intensity of silicon alloy (I_{alloy}) as to peak intensity of silicon (Iₛᵢ) measured by X-ray Diffractometer is in the range of 0.2˜5 in order to define the silicon amount in the silicon alloy.

5. The composite silicon anode material according to claim 4, the ratio (I_{alloy}/Iₛᵢ) of peak intensity of silicon alloy (I_{alloy}) as to peak intensity of silicon (Iₛᵢ) measured by X-ray Diffractometer is preferably in the range of 0.4˜2.0 in order to define the silicon amount in the silicon alloy.

6. The composite silicon anode material according to claim 1, said preparation steps further comprise a reforming step from silicon alloy powder into amorphous silicon alloy powder before preparing a support.

7. The composite silicon anode material according to claim 1, the ratio (W_{after}/W_{before}) of full width at half maximum of silicon alloy powder after reforming the silicon alloy powder as to that of before reforming the silicon alloy powder measured by X-ray Diffractometer is in the range of 1.05˜30 in order to define the amorphous degree of reformed silicon alloy.

8. The composite silicon anode material according to claim 7, the ratio (W_{after}/W_{before}) of full width at half maximum of silicon alloy powder after reforming the silicon alloy powder as to that of before reforming the silicon alloy measured by X-ray Diffractometer is preferably in the range of 1.1˜10 in order to define the amorphous degree of reformed silicon alloy.

9. The composite silicon anode material according to claim 1, the roundness of amorphous silicon alloy powder is in the range of 40˜100% in order to define the shape of amorphous silicon alloy powder.
